(19) United States
(12) Patent Application Publication
(10) Pub. No.: US 2006/0212584 A1
(43) Pub. Date: Sep. 21, 2006

(54) Method and system for accelerating downloading of web page content by a peer-to-peer network

(75) Inventors: Mingjian Yu, Beijing (CN); Zhenchun Li, Beijing (CN)

Correspondence Address: HAYNES AND BOONE, LLP, 901 MAIN STREET, SUITE 3100, DALLAS, TX, 75202, US

(73) Assignee: Qian Xiang Shi Ji (Beijing) Technology Development Co. Ltd., Beijing (CN)

(21) Appl. No.: 11/314,581

(22) Filed: Dec. 21, 2005

Related U.S. Application Data
(60) Provisional application No. 60/662,131, filed on Mar. 15, 2005.
(60) Provisional application No. 60/719,423, filed on Sep. 22, 2005.

(51) Int. Cl. G06F 15/16

(52) U.S. Cl. 709/227

(57) ABSTRACT

A method and system for accelerating downloading and displaying of content in web pages in a peer-to-peer network is provided. A peer-to-peer network client captures a download request from a web browser, and submits a query that includes an identifier of the file to an indexing server. The peer-to-peer network client receives a peer list including connectivity information of a peer node that has stored at least a portion of the file content. The peer-to-peer network client then connects with the peer node, and downloads the portion from the peer node. The peer-to-peer client conveys the downloaded portion to the web browser.

### RELATED APPLICATION DATA

This patent application claims the benefit of provisional U.S. Patent Application Ser. No. 60/662,131, filed Mar. 15, 2005, and provisional U.S. Patent Application Ser. No. 60/719,423, filed Sep. 22, 2005.

### BACKGROUND

In a client-server network adapted to provide content, such as hypertext markup language (HTML) pages to clients, many clients may concurrently connect with a server. The processing capacity of a server in such a network is limited. If the number of clients connected to the server exceeds the processing or transmission capacity of the server, the media server may be unable to provide a high quality of service to the clients, crash, discontinue service to clients, or refuse connections to clients.

Peer-to-peer networking solutions reduce or eliminate capacity deficiencies that are common in client/server network configurations. Peer-to-peer network technologies distribute processing and transmission demands among peer clients in the network. Thus, as a peer-to-peer network grows in size, so to does the processing and transmission capacity of the peer-to-peer network.

Traditional web page browsers download a web page from a web server. If the web page contains more content to be displayed, such as images, macromedia flash files in embedded flash players, multimedia files in embedded windows media players, or the like, the browser activates additional downloading processes and downloads these files. This download process may consume an undesirable amount of time, particularly when the multimedia files are large in size.

### BRIEF DESCRIPTION OF THE DRAWINGS

Aspects of the present disclosure are best understood from the following detailed description when read with the accompanying figures, in which:

FIG. 1 is a diagrammatic representation of an embodiment of a traditional web page content downloading process;

FIG. 2 is a diagrammatic representation of an embodiment of a client-server network that may facilitate storage and retrieval of data content to various clients;

FIG. 3 is a diagrammatic representation of an embodiment of a peer-to-peer network that may facilitate content delivery to various peer clients;

FIG. 4 is a diagrammatic representation of an embodiment of a peer-to-peer network that facilitates data distribution among various peer clients;

FIG. 5 is a flowchart of an embodiment of a peer client processing routine for downloading file content in a peer-to-peer network;

FIG. 6 is a diagrammatic representation of an embodiment of a system configuration for capturing requests submitted through a web browser that facilitates peer-to-peer exchange of content;

FIG. 7 is a diagrammatic representation of an embodiment of a peer-to-peer network configuration that facilitates data distribution by way of a proxy mechanism; and

FIG. 8 is a diagrammatic representation of an embodiment of data segmentation for facilitating content delivery and display by a peer node.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

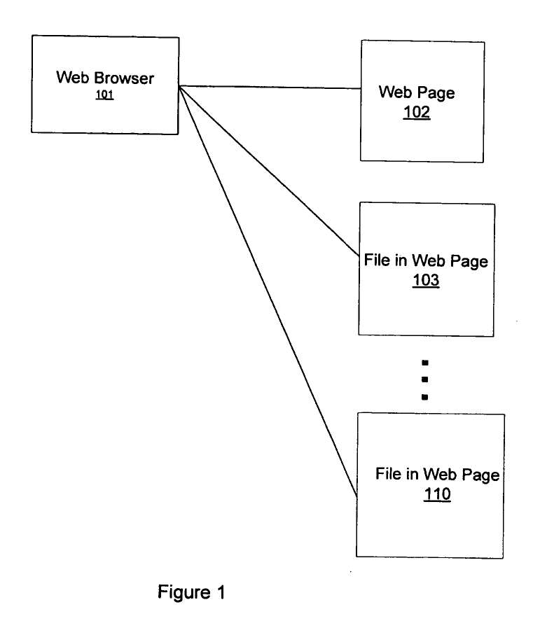

FIG. 1 is a diagrammatic representation of an embodiment of a traditional web page content downloading process. A web browser 101 running on a client computer requests a web page 102 from a source server by way of a uniform resource locator that specifies a network location or address of web page 102. After retrieving the web page or part of the web page, the web browser analyzes the content in the web page to determine if there are additional components 103-110, such as images, ActiveX objects, Macromedia flash files in an embedded flash player, multimedia files in an embedded Windows Media Player, or other embedded content, in the web page to be downloaded. Web browser 101 may then activate additional processes to download embedded components, if any. Some components may be displayed within the web page while the file is being downloaded, such as images or Flash files in ActiveX objects.

The mechanism for downloading files and content embedded therein for a conventional web browser includes accessing the source server(s) directly. As numerous clients access the source server, the quality of service of the source server may be adversely effected. The downloading process may often consume a substantial time to complete the retrieval of files from the source server.

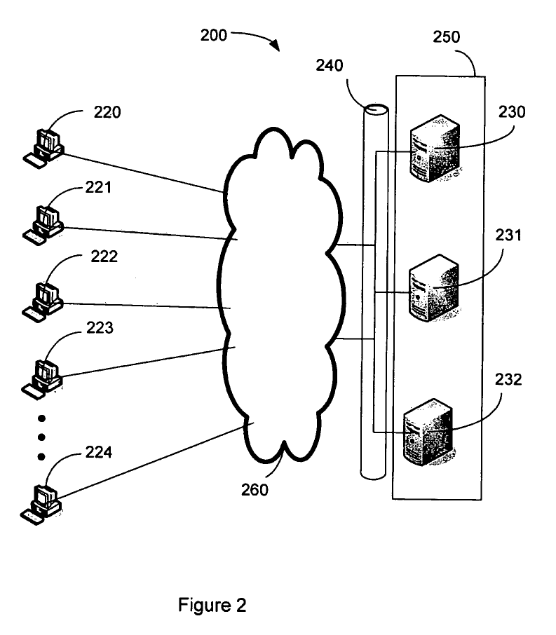

FIG. 2 is a diagrammatic representation of an embodiment of a client-server network 200 that may facilitate storage and retrieval of data content, such as web pages, to various clients 220-224. Client-server network 200 comprises multiple content servers 230-232 configured in a cluster 250. Content servers 230-232 may store or otherwise access duplicate content. Content servers 230-232 may be interconnected by a network link 240, such as an Ethernet. Content provided by cluster 250 may be load-balanced among content servers 230-232. Clients 220-224 are provided content by connecting with cluster 250, for example by way of a public network 260, such as the Internet.

Each of content servers 230-232 may provide content delivery services for a finite number of clients, and thus the client service capacity of cluster 250 is limited to the aggregate service capacity of content servers 230-232. If the demand placed on cluster 250 becomes too large, the service quality provided to clients 220-224 may be degraded or one or more of clients 220-224 may be disconnected from cluster 250. Conventional solutions for addressing excessive loads placed on cluster 250 generally include expanding the processing capacity of cluster 250, for example by adding additional content servers to cluster 250, upgrading the capacity of existing content servers, or by other mechanisms. Such system reconfigurations are costly due to both hardware and labor expenses.

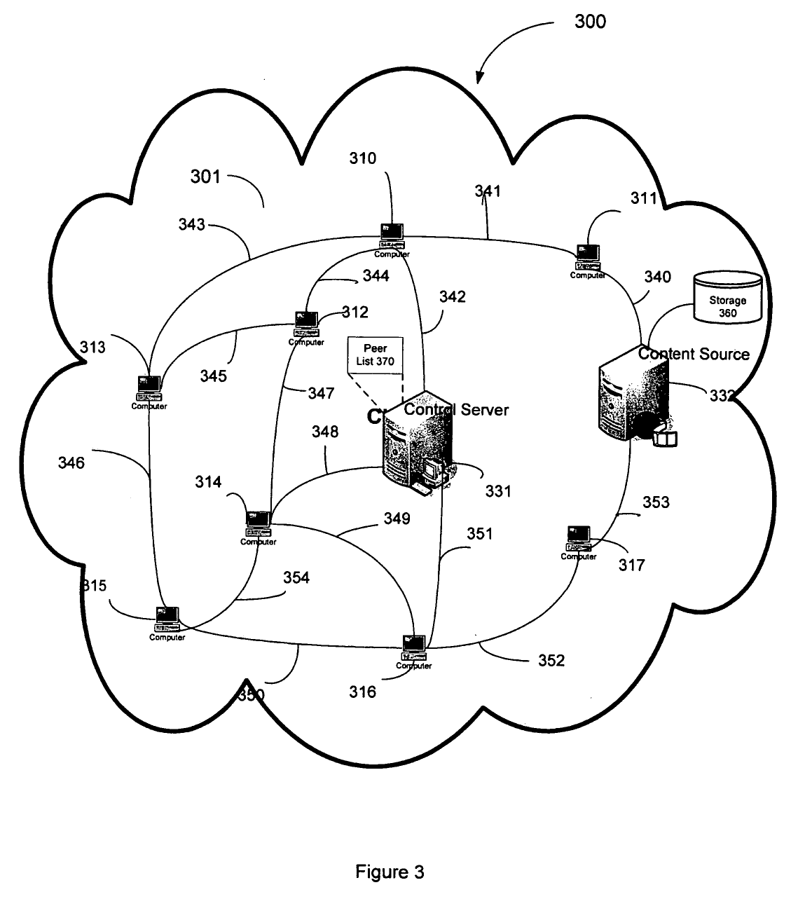

FIG. 3 is a diagrammatic representation of an embodiment of a peer-to-peer network 300 that may facilitate content delivery to various peer clients 310-317. Network 300 includes peer clients 310-317 that may be interconnected with other clients in network 300. Additionally, network 300 may include a control server 331 and a content source 332. One or more clients may connect with control server 331 and content source 332 in addition to other network clients. Clients 310-317 may connect with other network clients, control server 331 and content source 332 by network connections 340-354, such as wire, wireless communication links, fiber optic cables, or other suitable network media.

Control server 331 may facilitate connection of new clients within network 300 and organize clients 310-317 that have joined network 300. Clients 310-317 may be implemented as data processing systems, such as personal computers, wired or wireless laptop computers, personal digital assistants, or other computational devices capable of network communications.

Content source 332 may be implemented as a server that stores or accesses content, such as HTML content, streaming video, audio, or the like, and transmits the data to one or more clients in network 300. For example, the content may be retrieved from a file that is accessed by content source 332 from a storage device 360. Content source 332 may divide content into data segments that are distributed within network 300 as described more fully below. Various clients 310-317 may receive and store different data blocks of the content.

Control server 331 maintains a peer list 370 that includes connectivity information, such as a network address and port number, of respective peer clients that are connected within peer-to-peer network 200. When control server 331 generates peer list 370, connectivity information of content source 332 may be the only connectivity information included in peer list 370. A client joins peer-to-peer network 300 by first connecting with control server 331 and submitting a request for peer list 370. The control server returns peer list 370 to the requesting client, and the client joins network 300 by selecting one or more nodes having connectivity information included in peer list 370 and connecting with the selected nodes.

When a new client joins peer-to-peer network 300, control server 332 may add connectivity information of the newly joining client to peer list 370. In this manner, as additional clients join peer-to-peer network 300, the availability of peer clients with which subsequently joining clients may connect is increased. Connectivity information of content source 332 may be removed from peer list 370, for example when the number of clients connected within peer-to-peer network 300 reaches a pre-defined threshold. In this manner, the load placed on content source 332 may be reduced. A client connected within peer-to-peer network 300 that desires content originally provided by content source 332 may submit a query for the content to peer clients with which the requesting client is connected. If no peer clients within network 300 have the requested content (or no peer clients within network 300 are available for delivery of the content to the requesting client), the requesting client may obtain the content from content source 332.

A peer client that receives content from content source 332 may be configured to cache or temporarily store the content (or a portion thereof) for playback. Additionally, a client may distribute cached streaming content to other peer clients. Content may be segmented by content source 332 into data blocks or segments that each have an associated sequence number. Playback or display of content is performed by arranging data blocks into a proper sequence based on the data blocks' sequence numbers. Network 300 may comprise a transient Internet network, and thus clients 310-317, control server 331, and content source 332 may use the Transmission Control Protocol/Internet Protocol (TCP/IP) suite of protocols to communicate with one another. Alternatively, network 300 may be implemented in any number of different types of networks, such as for example, an intranet, a local area network (LAN), or a wide area network (WAN). Additionally, control server 331 and content source 332 are shown as distinct entities within network 300. However, control server 331 and content source 332 may be collectively implemented in one or more common network nodes. FIG. 3 is intended as an example, and not as an architectural limitation, of embodiments described herein.

Embodiments disclosed herein provide mechanisms for downloading web content within a peer-to-peer network. Advantageously, the load of the source server which originates the content may be reduced as the content is distributed within the peer-to-peer network and the downloading speed within the peer-to-peer system may be increased.

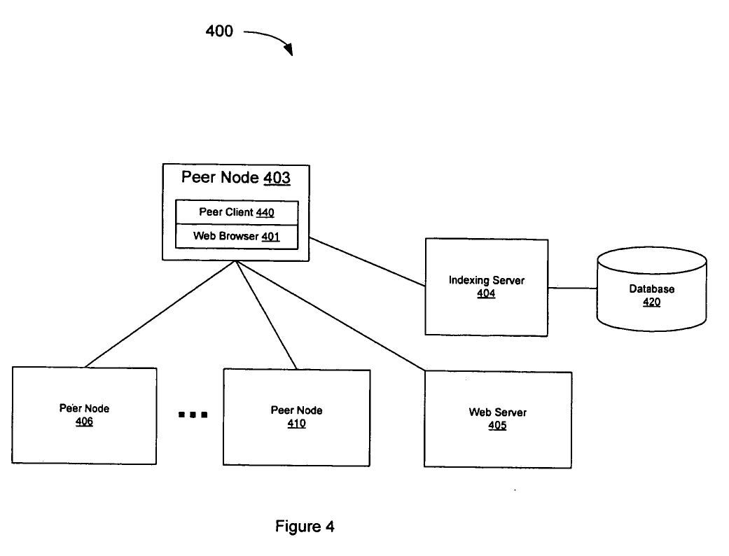

FIG. 4 is a diagrammatic representation of an embodiment of a peer-to-peer network 400 that facilitates data distribution. A peer client 440 is run by a peer node 403. Peer client 440 first captures a download request of a web browser 401 run by peer node 403. For example, a user may enter a request for content in web browser 401 running on peer node 403. The request entered by the user may, for example, comprise a URL entered in an address field of web browser 401. Peer client 440 may read or otherwise retrieve the content identifier from the request and may formulate or otherwise generate a query that includes the identifier. For example, functions of the present embodiment may be implemented as computer instructions implemented as a hook that receives a URL entered in an address field of browser 401 and temporarily interrupts or suspends the browser retrieval functionality. Peer client 440 may take over data retrieval functions of browser 401 if the requested content, or a portion thereof, is available in network 400. Accordingly, browser 401 does not attempt to connect to the network address specified by the URL unless the suspension of retrieval functionality is released by client application 440. After receiving the content identifier, peer client 440 may then send a query including the content identifier to an indexing server 404. Indexing server 404 maintains or interfaces with a database 420 or other suitable data structure that maintains records of content and identifiers associated therewith that are stored, at least in part, within peer-to-peer network 400. Preferably, identifiers of peer nodes maintaining particular content are maintained in association with identifiers of the content. For example, content identifiers, such as web page URLs, may be recorded in association with peer node identifiers, such as network addresses of peer nodes. The peer node identifiers and content identifiers may be recorded in database 420. In this manner, indexing server 404 may query database 420 with a content identifier read or otherwise retrieved from a query submitted by a peer node, such as peer node 403. Indexing server 404 may generate a peer list that includes connectivity information, such as respective network addresses, of one or more peer nodes 406-410, if any, that currently maintain the requested content specified by the identifier in the query submitted by peer node 403. The connection information may include the IP address and listening port of the peer, or other connectivity information. The peer list may then be returned to the querying peer client 440 in a query response. If no peer is available in the returned query response, peer client 440 may connect to the source server and download the file. Alternatively, peer client 440 may pass control back to browser 401, and browser 401 may subsequently connect with the source server and download the file. For example, assume the URL of the requested content specifies an address hosted by web server 405 external to peer-to-peer network 400. In the event that no peer nodes 406-410 currently maintain the requested content, browser 401 may be directed to connect with web server 405 to obtain the requested content therefrom.

Notably, the location of content, such as a web page, within peer-to-peer network 400 is not specified by a file URL but rather by the association of the URL, or other suitable identifier, with a peer node identifier, such as a peer node address. In other implementations, a peer client may use an identifier derived from a file URL as a content identifier rather than the URL itself.

In some implementations, a peer node and URL association may not uniquely determine a file location within network 400. For example, a source server that originated a particular file may change the file that is located at a particular URL for providing another web service or other content. In order to provide a unique identifier for the file, a peer client may connect to the source server and retrieve the file size and the last modification time of the file. The client then uses a combination of file URL, file size and file's last modification time as an identifier of the file or a derived format of the combination. Accordingly, indexing server 404 may maintain additional information related to content maintained in network 400 in association with the content identifier and identifications of peer node(s) that maintain the content. For example, indexing server 404 may maintain file size and modification time in association with an identifier of the file or content and identifications of any peer nodes that maintain the content within network 400.

In addition to connectivity data of any peer nodes and/or a content source, such as web server 405, that maintains requested content, a peer list generated by indexing server 404 may include connectivity information of mirror sites of the content source. Directing peer nodes to retrieve content from a mirror site may facilitate a reduction in the load placed on the source server.

If there are available peers in the peer list returned to peer client 440 from indexing server 404, client 440 may then connect to one or more of the peers identified in the peer list, send a query with the file identifier to the peers, and retrieve the file, or a portion thereof, from the peers. If the client retrieves only a portion of the file, the client may specify start and end positions of the file, e.g., by way of specifying particular data blocks or segments of the file.

Other peers, such as peer nodes 406-410 in peer-to-peer network 400 may be configured in a similar manner as peer node 403 and thus may retrieve content in a similar manner as that described with regard to peer node 403. Additionally, peer nodes 403 and 406-410 may provide uploading services within network 400. A peer client preferably listens at a particular port and waits for connections from other peer nodes within network 400. In this manner, requests for content from other peer nodes is made over the port, and a peer node may then provide other peer nodes with uploading service in response to a request for content.

When a peer client downloads content of a file, either from other peers or from the source server, it may save the file or portion of the file into a file cache. In this manner, the peer client may provide uploading service of the file. The peer client may determine whether to save a downloaded file according to some pre-defined rule, e.g., based on the client's free disk space, the client's bandwidth, etc. If the peer client does save the file, or a portion thereof, the peer client preferably reports information of the saved file to indexing server 404. Indexing server 404 may update database 420 to indicate that the client currently has the file stored and available for upload to other peer clients.

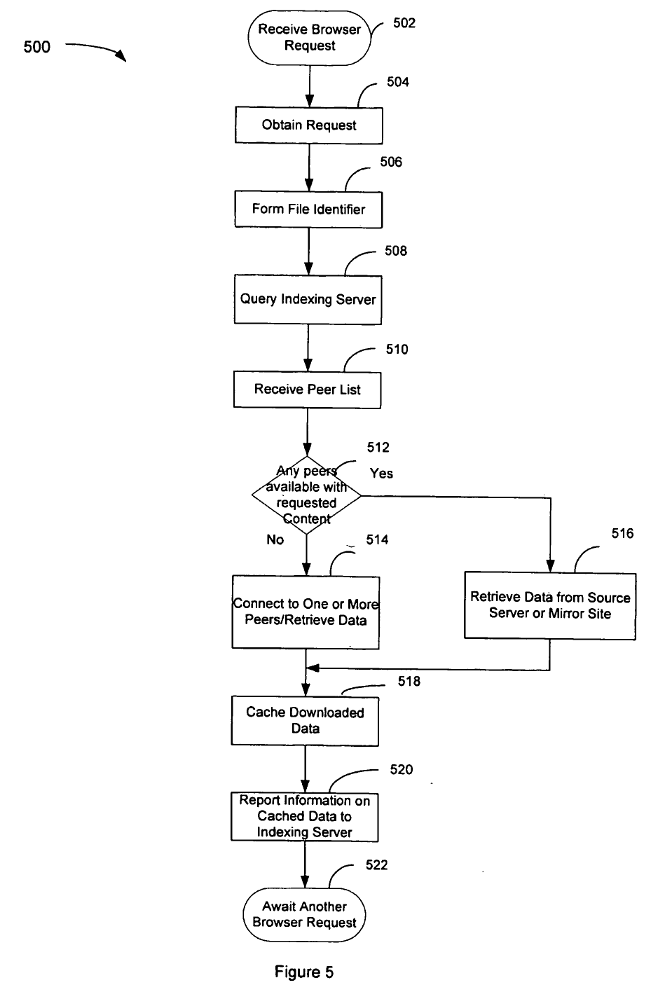

FIG. 5 is a flowchart of an embodiment of a peer client processing routine for downloading file content in a peer-to-peer network. When the browser receives a request for a file (step 502), the peer client obtains the request (step 504) and forms a file identifier therefrom (step 506). For example, the peer client may use a URL obtained from the browser request as the file identifier or an identifier derived from the URL. The peer client then queries the indexing server with a request for the file (step 508). The query submitted to the indexing server may include an identifier of the file obtained from the browser request or an identifier derived therefrom. The peer client then awaits receipt of a peer list from the indexing server (step 510). The peer client evaluates the peer list to determine if any peer nodes maintain the requested content (or a portion thereof) and are available within the peer-to-peer network (step 512).

If the peer list does not specify any peer node, the peer client may retrieve the file from the source server or a mirror site thereof (step 516). For example, connectivity information of mirror sites of a source server may be included in the peer list to facilitate reducing the load placed on the source server. If no peer nodes or mirror sites are specified in the peer list, the peer client processing routine may pass control back to the browser such that the browser connects with the source server, e.g., according to the URL of the original browser request. After retrieving the content from the source server or a mirror site thereof, the peer client may proceed to cache the retrieved content (step 518) to make the content available for other peer clients.

Returning again to step 512, if the peer list does identify peer nodes that have the requested content, the peer client may then proceed to connect to one or more of the peer nodes identified in the peer list and retrieve the requested content therefrom (step 514). After the data is downloaded from the one or more peers, the peer client may cache the retrieved content according to step 518.

The peer client may report information, e.g., the content identifier, size, content segment identifiers, or the like, regarding content that is cached to the indexing server (step 520). The client processing routine may then proceed to await another browser request (step 522).

Information reported to the indexing server according to step 520 regarding cached content is saved by the indexing server in a record or other data structure to properly indicate the content maintained by the reporting peer client. When a peer client requests a peer list for particular content, the indexing server retrieves correlated data records from the database, and returns a peer list to the requesting peer client. Each peer record of a peer list includes connection information, such as IP address and listening port, of a peer maintaining the requested content.

To enhance the reliability of information provided in peer lists to querying peer nodes, the indexing server may record online status information of peer nodes within the peer-to-peer network. To this end, each peer node may report its online status to the indexing server upon joining the peer-to-peer network. Likewise, a peer node may report its imminent exit from the network prior to exiting the peer-to-peer network. The indexing server preferably maintains the online status of each peer node.

In another embodiment, a peer client may download a portion of content from one source and another portion (or portions) from another source (or sources). For example, a peer client may download an HTML page from a source server of the HTML page, and download embedded content of the HTML page from one or more peer clients in a peer-to-peer network. In this method, downloading of data intensive portions of an HTML page are effectively offloaded to the peer-to-peer network thereby decreasing the load placed on the source server of the HTML page.

As noted above, embodiments of the present disclosure are implemented by capturing a request for a file or other data structure submitted through a web browser. To this end, the peer client may register callbacks, include a modified system configuration, and/or include modifications of a web browser. Three exemplary mechanisms for capturing the request from the web browser are described below. The first two example embodiments may be implemented on MICROSOFT INTERNET EXPLORER web browser, and the third mechanism may be applicable to Internet Explorer or for other browsers.

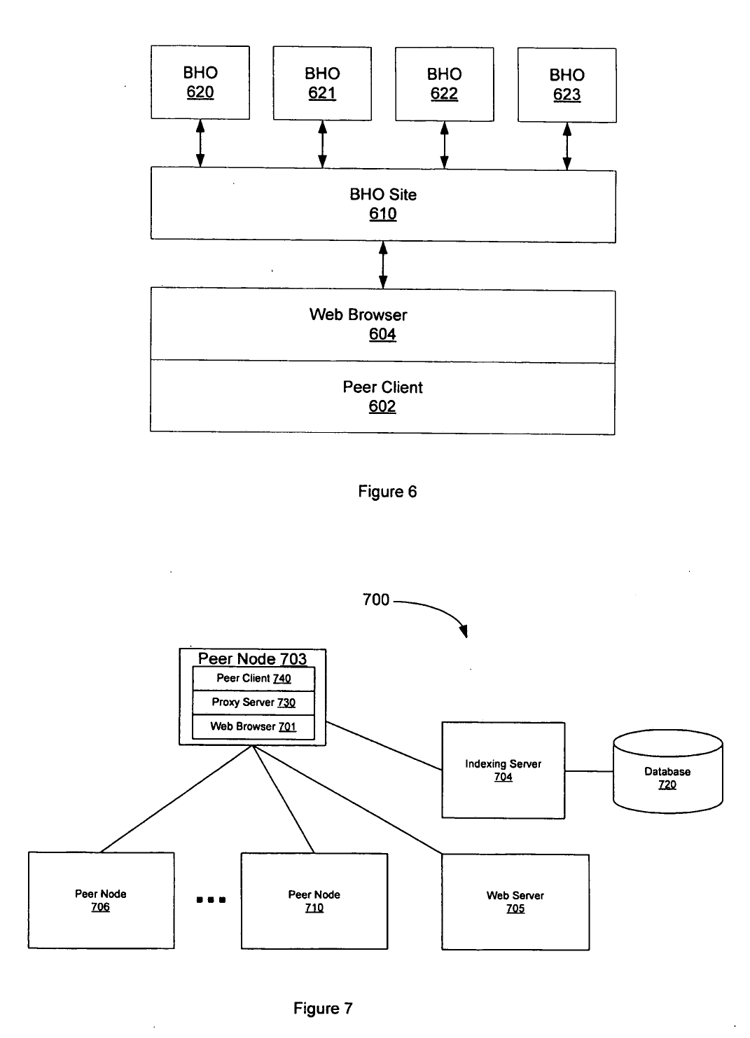

FIG. 6 is a diagrammatic representation of an embodiment of a system configuration for capturing requests submitted through a web browser that facilitates peer-to-peer exchange of content. A web browser 604, such as INTERNET EXPLORER manufactured by MICROSOFT CORPORATION of Redmond, Wash., and a peer client 602 are run by a peer node. A browser helper object (BHO) site 610 provides a component object model (COM) interface used to provide communications. Web browser 604 may automatically load various browser helper objects (BHOs) 620-623 into its memory space on start up of web browser 604. A BHO is a COM in-process server registered under a particular registry's key. Upon startup, web browser 604 looks up the key and loads all the objects whose CLSID is stored there. The CLSID comprises a globally unique identifier that specifies a COM class object. The browser initializes the object and requests a certain interface. If that interface is found, web browser 604 may use the methods provided to pass its IUnknown pointer down to the helper object. The browser may find a list of CLSIDs in the registry and create an in-process instance of each. As a result, such objects are loaded in the browser's context and can operate as if the objects are native components of the browser. In the installed BHO, an interface for the Internet Protocol is registered and implemented.

Each of BHOs 620-623 may perform respective functions that facilitate exchange of content in a peer-to-peer network in accordance with embodiments disclosed herein. For example, BHO 620 may provide functionality that detects a web browser control event, such as a navigate event that indicates browser 604 will soon navigate to a new web site, and that obtains information from the event. For example, BHO 620 may retrieve the URL from a browser control event that identifies a network location which the browser will navigate to without further intervention by one of BHOs 620-623. BHO 620 may pass the obtained URL to another BHO, such as one or more of BHOs 621-623. Other BHOs, such as BHO 621, may provide functionality for temporarily suspending or interrupting browser functionality by interfacing with the browser control to suspend the imminent navigation to a new site. Still other BHOs may generate a content identifier and query the indexing server with the content identifier, while another BHO may process a peer list returned from the indexing server. Yet another BHO may be responsible for instigating connections with other peer nodes for retrieval of the requested content and passing the content to web browser 604. The BHOs depicted are exemplary only and functionality of the present embodiment may be implemented in one or more BHOs.

In another embodiment, a permanent protocol handler may be registered for the web browser, such as Internet Explorer. In this implementation, a registration item or method for a protocol is registered in the operating system, such as MICROSOFT WINDOWS. When the browser receives data formatted according to the protocol, the registered method associated with the protocol is loaded by the browser and processing of the data is passed to the method. The method includes logic for performing data exchange in a peer network as described above.

In yet another embodiment, a proxy of a web browser may be utilized to perform data exchange by a peer network. Many commercially available browsers have methods to setup proxy configurations. In this implementation, a proxy may be configured to pass processing to a module of the peer client from the browser, and the peer client may then take over data retrieval functions from the web browser. For example, the proxy may invoke methods, subroutines, or other logic that suspends retrieval functions of the web browser upon detection of a browser event, such as the beginning of a navigate event, and that passes control of data retrieval or exchange from the web browser to logic of the peer client.

FIG. 7 is a diagrammatic representation of an embodiment of a peer-to-peer network 700 configuration that facilitates data distribution by way of a proxy mechanism. Network 700 includes various peer nodes 703 and 706-710. An indexing server 704 manages network 700 and may maintain records, for example in a database 720, of content stored in network 700 and associated identifying data of peer nodes maintaining the content. In general, a web browser 701 may be configured to provide a different proxy for various protocols, such as HTTP, HTTPS, FTP, Gopher, etc. Each protocol may be assigned a proxy with the proxy's IP address and listening port. To this end, a peer node 703 may be configured with a proxy server 730 that manages the various proxies. After the proxy configuration, the requests of a particular protocol associated with a peer client 740 application running on peer node 703 are redirected to peer client 740. In this implementation, peer node 703 is configured as both a proxy server and a peer-to-peer client. Peer client 740 waits for a request from browser 701, processes a request captured therefrom, retrieves data from peer-to-peer network 700 and/or a source server 705 external to peer-to-peer network 700, and then returns the data to browser 701.

In accordance with an embodiment of the present disclosure, a peer client may selectively determine whether an attempt to retrieve requested content (or a portion thereof) is to be made from the peer-to-peer network. For example, the peer client may be configured to attempt retrieval of only data intensive content, e.g., media files such as shockwave Flash files, MPEG-formatted files, or other media content, from the peer-to-peer network. Accordingly, after capturing a request from a web browser, the peer client may evaluate the particular request and determine whether the content should be retrieved from the peer-to-peer network or the source server (or a mirror site thereof). For example, the peer client may be configured with one or more file extensions that are to be retrieved, if possible, from the peer-to-peer network.

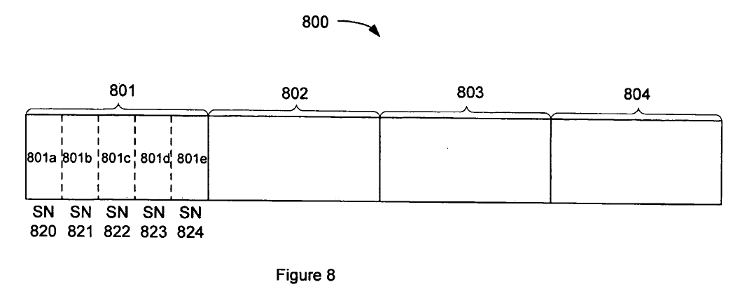

In another embodiment of the present disclosure, the display speed of content within a web browser may be accelerated by retrieving large files in data blocks or segments. FIG. 8 is a diagrammatic representation of an embodiment of data segmentation for facilitating content delivery and display by a peer node. In this implementation, a file 800 (or a portion thereof) is segmented into data blocks 801-804. Each data block may be further divided into sub-segments. For example, data block 801 is divided into sub-segments 801 a-801 e. In a similar manner, data blocks 802-804 may be further divided into sub-segments. Each sub-segment, or smallest unit of data, may have a sequence number assigned thereto to facilitate assembly of data segments or sub-segments that may be received out of order. The peer client may download each data block 801-804 sequentially. After download of each data block 801-804, the peer client may convey the downloaded data block to the web browser for a progressive display of the content downloaded up to that particular point. The peer client may use a multi-threaded downloading process for downloading data block sub-segments, e.g., sub-segments 801a-801e. Data block sub-segments may be downloaded concurrently.

As described, embodiments disclosed herein provide mechanisms for obtaining a request for content submitted through a browser. Control of the download process may be seized or otherwise appropriated to a peer client application. The peer client application may obtain an identifier of the requested content from the browser request. The peer client may then interrogate an indexing server with the content identifier. A peer list may be returned to the peer client that indentifies peer nodes in the peer-to-peer network that store the requested content, or a portion thereof. The peer client may then initiate connections with one or more of the peer clients for retrieval of at least a portion of the requested content. Accordingly, downloading of requested content may be offloaded to the peer-to-peer network thereby reducing the load placed on a source server of the requested content.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

What is claimed is:

1. A method of downloading data in a peer-to-peer network, comprising:
capturing a download request for a file from a web browser;
determining whether content of the file is stored in the peer-to-peer network;
responsive to determining at least a portion of the content is stored in the peer-to-peer network, connecting with a node of the peer-to-peer network; and
downloading the portion from the node.

2. The method of claim 1, further comprising conveying the portion to the web browser responsive to downloading the portion.

3. The method of claim 1, wherein capturing further comprises registering a processing method of a protocol in an instance of a web browser.

4. The method of claim 1, wherein capturing further comprises adding a registration item for a protocol to an operating system.

5. The method of claim 1, wherein capturing further comprises setting up a proxy for the web browser.

6. The method of claim 1, further comprising:
submitting a query that includes an identifier of the file to an indexing server; and
receiving a peer list including connectivity information of the peer node.

7. The method of claim 6, wherein receiving the peer list further comprises receiving the peer list including connectivity information of one or more file servers external to the peer-to-peer network.

8. The method of claim 7, further comprising:
connecting with at least one or more of the file servers; and
downloading portions of the file from at least one of the one or more file servers.

9. The method of claim 6, wherein submitting a query that includes an identifier further comprises submitting a query that includes the identifier that comprises at least one of a uniform resource locator and an identifier derived from the uniform resource locator.

10. The method of claim 9, wherein the identifier comprises at least one of a combination of a uniform resource locator, a file size and a last modification time and a derivation of the combination, wherein the file size and the last modification time are retrieved from a file server.

11. The method of claim 1, wherein downloading further comprises sequentially downloaded a plurality of blocks that comprise the portion.

12. The method of claim 11, wherein each of the plurality of blocks respectively comprises a randomized portion of the file.

13. The method of claim 1, further comprising:
saving the portion to a file cache; and
reporting the saved portion to an indexing server.

14. The method of claim 13, further comprising:
waiting for a query from a second peer node; and
returning data related to the query to the second peer node.

15. The method of claim 1, further comprising downloading a second portion of the file from a source server of the file, wherein the source server is external to the peer-to-peer network.

16. A computer-readable medium having computer-executable instructions for execution by a processing system, the computer-executable instructions for downloading data in a peer-to-peer network, comprising:
instructions of a peer-to-peer network client application that capture a download request for a file from a web browser;
instructions of the application that determine whether content of the file is stored in the peer-to-peer network;
instructions of the application that connect with a node of the peer-to-peer network in response to a determination being made that at least a portion of the content is stored in the peer-to-peer network; and
instructions of the application that download the portion from the node.

17. The computer-readable medium of claim 16, further comprising instructions that convey the portion to the web browser responsive to the portion being downloaded.

18. The computer-readable medium of claim 16, wherein the instructions that download the portion submit a query that includes an identifier of the file to an indexing server and receive a peer list including connectivity information of the peer node.

19. The computer-readable medium of claim 18, wherein the peer list includes connectivity information of one or more file servers external to the peer-to-peer network.

20. The computer-readable medium of claim 19, further comprising:
instructions that connect with at least one or more of the file servers; and
instructions that download portions of the file from at least one of the one or more file servers.

21. The computer-readable medium of claim 18, wherein the identifier comprises at least one of a uniform resource locator and an identifier derived from the uniform resource locator.

22. The computer-readable medium of claim 16, further comprising instructions that download a second portion of the file from a source server of the file, wherein the source server is external to the peer-to-peer network.

23. A peer-to-peer network for delivering content to peer clients, comprising, a first peer node that maintains a portion of a file; and
a second peer node that runs a web browser that receives a request for the file and a peer client application that captures the file request, wherein the peer client application connects with the first peer node, downloads the portion from the first peer node, and conveys the portion to the web browser.

24. The network of claim 23, further comprising an indexing server that maintains records of peer nodes registered in the peer-to-peer network and identifiers of content maintained by respective peer nodes.

25. The network of claim 24, wherein the peer client application generates a query including an identifier of the file, conveys the query to the indexing server, and receives a peer list from the indexing server that includes respective connectivity information of peer nodes of the network that maintain at least a portion of the file.

26. The network of claim 25, wherein the peer list includes connectivity information of a file server that maintains the file, wherein the file server is external to the peer-to-peer network.

27. The network of claim 25, wherein the identifier comprises one of a uniform resource locator of the file and a value derived from the uniform resource locator.

28. The network of claim 25, wherein the identifier is derived from the uniform resource locator, a file size and a file last modification time.

29. The network of claim 23, wherein the second peer node saves the portion of the file to a storage media and reports information of the saved portion to an indexing server.
